(19) United States
(12) Patent Application Publication
(10) Pub. No.: US 2025/0079074 A1
(43) Pub. Date: Mar. 6, 2025

(54) COIL ELECTRONIC COMPONENT

(71) Applicant: SAMSUNG ELECTRO-MECHANICS CO., LTD., Suwon-si (KR)

(72) Inventors: Minji Cho, Suwon-si (KR); Juhwan Yang, Suwon-si (KR); Boumseock Kim, Suwon-si (KR)

(73) Assignee: SAMSUNG ELECTRO-MECHANICS CO., LTD., Suwon-si (KR)

(21) Appl. No.: 18/752,478

(22) Filed: Jun. 24, 2024

(30) Foreign Application Priority Data
Sep. 4, 2023 (KR) 10-2023-0117027

(51) Int. Cl. H01F 27/29; H01F 27/28

(52) U.S. Cl. CPC H01F 27/292; H01F 27/2828

(57) ABSTRACT

A coil electronic component includes: a body surrounding a first coil with both ends exposed to the outside of the body and a second coil with both ends exposed to the outside of the body, and including a magnetic material; and external electrodes connected to the first coil and the second coil. One of the external electrodes includes an intermetallic compound disposed on the exposed ends of the first coil and the second coil, respectively.

### CROSS-REFERENCE TO RELATED APPLICATION

This application claims priority to and the benefit of Korean Patent Application No. 10-2023-0117027 filed in the Korean Intellectual Property Office on Sep. 4, 2023, the entire contents of which are incorporated herein by reference.

### TECHNICAL FIELD

The present disclosure relates to a coil electronic component.

### BACKGROUND

A coil electronic component with low loss and excellent efficiency has been used around a power management integrated circuit (PMIC) to extend battery life of a mobile device because power consumption is increased as the mobile device has recently provided various functions.

The coil electronic component having a coupled inductor structure in which a first coil and a second coil are stacked may use a four-terminal structure in which four external electrodes are connected to the first coil and the second coil. The external electrode with a four-terminal structure may be smaller than an external electrode with a two-terminal structure, and thus have a weak adhesion strength. Therefore, there is a need for a method to increase the adhesion strength of the external electrode with a four-terminal structure.

### SUMMARY

The present disclosure attempts to provide a coil electronic component with a coupled inductor structure that is capable of increasing an adhesion strength of an external electrode.

However, problems to be solved by embodiments of the present disclosure are not limited to the above-mentioned problems and may be variously expanded in a range of the spirit of the present disclosure included in the embodiments.

According to an embodiment, a coil electronic component may include: a body surrounding a first coil with both ends exposed to the outside of the body and a second coil with both ends exposed to the outside of the body, and including a magnetic material; and external electrodes connected to the first coil and the second coil. One of the external electrodes may include an intermetallic compound disposed on the exposed ends of the first coil and the second coil, respectively.

The one of the external electrodes may further include a conductive resin layer in contact with the intermetallic compound, and an electrode layer connected to the conductive resin layer.

The conductive resin layer may include a base resin, a plurality of metal particles disposed within the base resin, and a conductive connection portion surrounding the plurality of metal particles and being in contact with the intermetallic compound.

The electrode layer may be disposed on the conductive resin layer and be in contact with the conductive connection portion.

The intermetallic compound may be in the form of a plurality of islands.

The intermetallic compound may include silver (Ag)-tin (Sn).

The plurality of metal particles may have one of a spherical shape, a flake shape, and a mixture of spherical and flake shapes.

The first coil may include at least one turn of a first conductive wire, and the second coil may include at least one turn of a second conductive wire.

The first coil may include a first lead-out portion and a second lead-out portion that are exposed the outside of the body, and the second coil may include a third lead-out portion and a fourth lead-out portion that are exposed the outside of the body.

The intermetallic compound may be disposed on exposed surfaces of the first lead-out portion, the second lead-out portion, the third lead-out portion, and the fourth lead-out portion.

The external electrodes may include a first external electrode connected to the first lead-out portion, a second external electrode connected to the second lead-out portion, a third external electrode connected to the third lead-out portion, and a fourth external electrode connected to the fourth lead-out portion.

According to another embodiment, a coil electronic component may include: a body surrounding a first coil with both ends exposed to the outside of the body and a second coil with both ends exposed to the outside of the body, and including a magnetic material; a metal layer disposed outside the body and being in contact with the exposed ends of the first coil and the second coil, respectively; and external electrodes connected to the metal layer. One of the external electrodes may include an intermetallic compound disposed on the metal layer.

The metal layer may include copper (Cu).

The one of the external electrodes may further include a conductive resin layer in contact with the intermetallic compound, and an electrode layer connected to the conductive resin layer.

The conductive resin layer may include a base resin, a plurality of metal particles disposed within the base resin, and a conductive connection portion surrounding the plurality of metal particles and being in contact with the intermetallic compound.

The electrode layer may be disposed on the conductive resin layer and be in contact with the conductive connection portion.

The intermetallic compound may include silver (Ag)-tin (Sn).

The first coil may include a first lead-out portion and a second lead-out portion that are exposed the outside of the body, and the second coil may include a third lead-out portion and a fourth lead-out portion that are exposed the outside of the body.

The intermetallic compound may be disposed on exposed surfaces of the first lead-out portion, the second lead-out portion, the third lead-out portion, and the fourth lead-out portion.

The external electrodes may include a first external electrode connected to the first lead-out portion, a second external electrode connected to the second lead-out portion, a third external electrode connected to the third lead-out portion, and a fourth external electrode connected to the fourth lead-out portion.

According to another embodiment, a coil electronic component may include: a body including a magnetic material; a first coil disposed in the body and including first and second lead-out portions extending to one surface of the body; a second coil stacked on or below the first coil inside the body, and including third and fourth lead-out portions extending to the one surface of the body; first to fourth external electrodes disposed on the one surface of the body to respectively connect to the first to fourth lead-out portions; a metal layer disposed between a respective one of the first to fourth external electrodes and a respective one of the first to fourth lead-out portions. The metal layer may have an area greater than an area of the respective one of the first to fourth lead-out portions exposed from the one surface of the body.

The respective one of the first to fourth external electrodes may include: an intermetallic compound disposed on the metal layer, a conductive resin layer in contact with the intermetallic compound, and an electrode layer connected to the conductive resin layer.

The coil electronic component according to the embodiments may increase the adhesion strength of the external electrode, which is a four-terminal structure, of a coupled inductor.

### BRIEF DESCRIPTION OF THE DRAWINGS

FIG. 1 is a perspective view schematically illustrating a coil electronic component according to an embodiment.

FIG. 2 is a plan view schematically illustrating the coil electronic component of FIG. 1.

FIG. 3 is a bottom perspective view schematically illustrating the coil electronic component of FIG. 1.

FIG. 4 is a schematic cross-sectional view taken along line IV-IV′ in FIG. 1.

FIG. 5 is a partially enlarged cross-sectional view schematically illustrating the lead-out portion of the coil and the external electrode of the coil electronic component of FIG. 1.

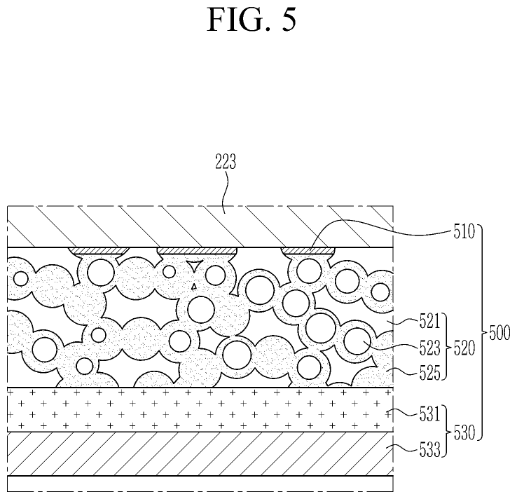

FIG. 6 is a view illustrating that a conductive resin layer of FIG. 5 includes flake-shaped metal particles.

FIG. 7 is a view illustrating that the conductive resin layer of FIG. 5 includes both spherical metal particles and flake-shaped metal particles.

FIG. 8 is a perspective view schematically illustrating a coil electronic component according to another embodiment.

FIG. 9 is a perspective view schematically illustrating a coil electronic component according to still another embodiment.

FIG. 10 is a perspective view schematically illustrating a coil electronic component according to yet another embodiment.

FIG. 11 is a partially enlarged cross-sectional view schematically illustrating the lead-out portion of the coil and the external electrode of the coil electronic component of FIG. 10.

### DETAILED DESCRIPTION OF THE EMBODIMENTS

Hereinafter, embodiments of the present disclosure will be described in detail with reference to the accompanying drawings for those skilled in the art to which the present disclosure pertains to easily practice the present disclosure. A portion unrelated to the description is omitted in order to obviously describe the present disclosure, and the same or similar components are denoted by the same reference numeral throughout the specification. In addition, it is to be noted that some components shown in the accompanying drawings are exaggerated, omitted or schematically illustrated, and the size of each component does not exactly reflect its real size.

It should be understood that the accompanying drawings are provided only to allow the embodiments of the present disclosure to be easily understood, and the spirit of the present disclosure is not limited by the accompanying drawings, and includes all the modifications, equivalents, and substitutions included in the spirit and scope of the present disclosure.

Terms including ordinal numbers such as “first,” “second,” and the like may be used to describe various components. However, these components are not limited by these terms. The terms are used only to distinguish one component from another component.

In addition, when an element such as a layer, a film, a region or a board is referred to as being “on” or “above” another element, the element may be “directly on” another element or may have a third element interposed therebetween. On the contrary, when an element is referred to as being “directly on” another element, there is no third element interposed therebetween. In addition, when an element is referred to as being “on” or “above” a reference element, the element may be positioned on or below the reference element, and may not necessarily be “on” or “above” the reference element in an opposite direction of gravity.

It should be understood that terms “include” and “comprise” used in this specification specify the presence of features, numerals, steps, operations, components, parts mentioned in this specification, or combinations thereof, and do not preclude the presence or addition of one or more other features, numerals, steps, operations, components, parts, or combinations thereof. Unless explicitly described to the contrary, “including” any component will be understood to imply the inclusion of other components rather than the exclusion of other components.

Further, throughout the specification, an expression “on the plane” may indicate a case where a target is viewed from the top, and an expression “on the cross-section” may indicate a case where a cross-section of a target taken along a vertical direction is viewed from its side.

In addition, when it is mentioned that any component is “connected” to another component, it may not only indicate that two or more components are directly connected with each other, but also indicate that two or more components are connected with each other indirectly through another component, may not only indicate that two or more components are physically connected with each other, but also indicate that two or more components are electrically connected, or two or more components are a single entity although referred to by different names depending on their locations or functions.

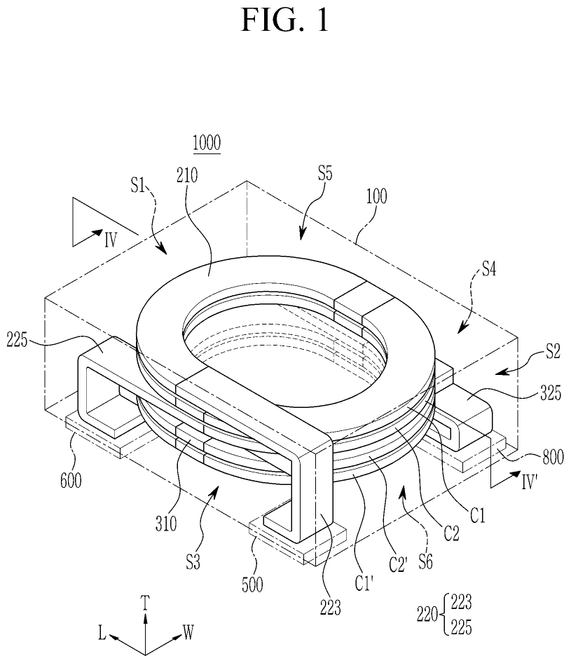

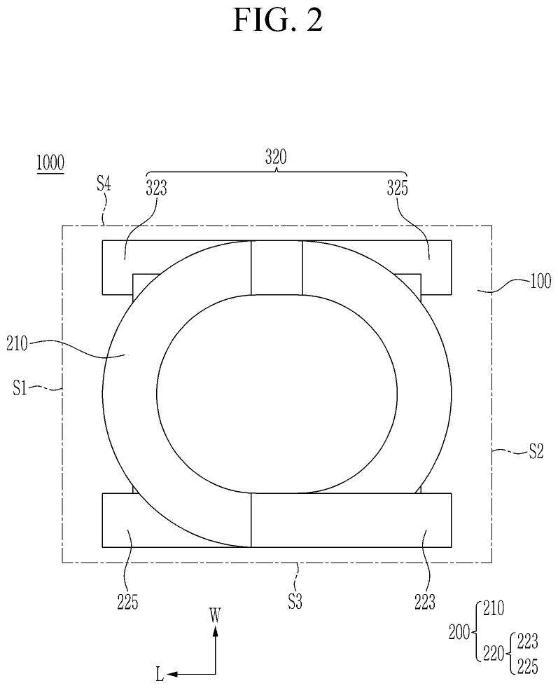

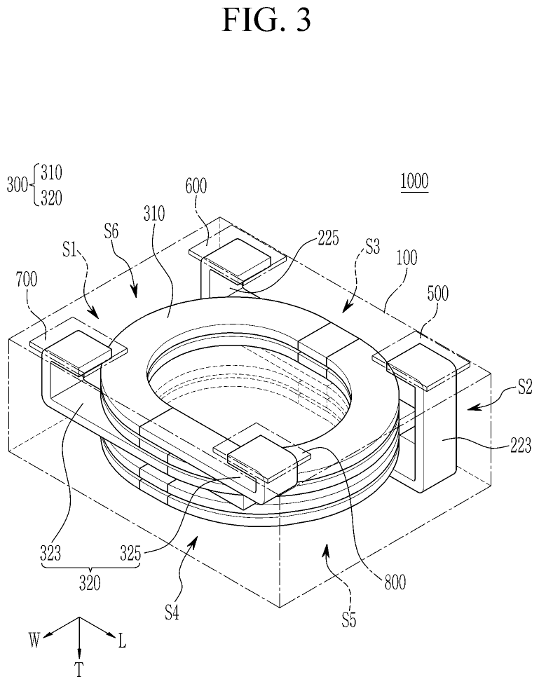

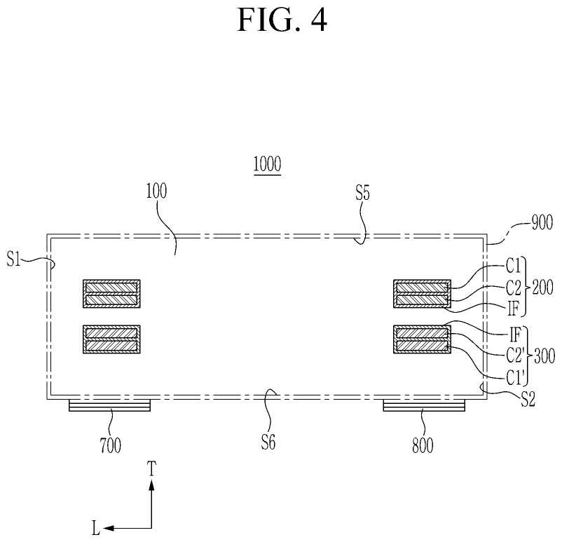

FIG. 1 is a perspective view schematically illustrating a coil electronic component according to an embodiment, FIG. 2 is a plan view schematically illustrating the coil electronic component of FIG. 1, FIG. 3 is a bottom perspective view schematically illustrating the coil electronic component of FIG. 1, and FIG. 4 is a schematic cross-sectional view taken along line IV-IV′ in FIG. 1.

Referring to FIGS. 1, 2, 3, and 4, a coil electronic component 1000 according to an embodiment may include a body 100, a first coil 200, a second coil 300, and a first external electrode 500, a second external electrode 600, a third external electrode 700, and a fourth external electrode 800.

The body 100 may have a substantially rectangular parallelepiped shape, but the present embodiment is not limited thereto. As magnetic powder or the like shrink during sintering, the body 100 may have a substantially rectangular parallelepiped shape, although not a completely rectangular parallelepiped shape. For example, the body 100 may have a substantially rectangular parallelepiped shape, but portions corresponding to a corner or a vertex may have a round shape.

In this embodiment, for convenience of explanation, two opposing surfaces of the body 100 in a length direction (or an L-axis direction) are respectively defined as a first surface S1 and a second surface S2, two opposing surfaces of the body 100 in a width direction (or a W-axis direction) are respectively defined as a third surface S3 and a fourth surface S4, and two opposing surfaces of the body 100 in a thickness direction (or a T-axis direction) are respectively defined as a fifth surface S5 and a sixth surface S6.

A length of the coil electronic component 1000 may refer to the maximum value among lengths of a plurality of line segments parallel to the length direction (or the L-axis direction) and each connecting two outermost boundary lines of the coil electronic component 1000 opposing each other in the length direction (or the L-axis direction) that are shown in an optical microscope or scanning electron microscope (SEM) photograph of a cross-section taken in the length direction (or the L-axis direction) and the thickness direction (or the T-axis direction) at the center of the coil electronic component 1000 in the width direction (or the W-axis direction). Alternatively, the length of the coil electronic component 1000 may refer to the minimum value among lengths of a plurality of line segments parallel to the length direction (or the L-axis direction) and each connecting two outermost boundary lines of the coil electronic component 1000 opposing each other in the length direction (or the L-axis direction) that are shown in the above-mentioned photograph of the cross-section. Alternatively, the length of the coil electronic component 1000 may refer to an arithmetic average of lengths of at least two line segments among the plurality of line segments parallel to the length direction (or the L-axis direction) and each connecting two outermost boundary lines of the coil electronic component 1000 opposing each other in the length direction (or the L-axis direction) that are shown in the above-mentioned photograph of the cross-section.

A thickness of the coil electronic component 1000 may refer to the maximum value among lengths of a plurality of line segments parallel to the thickness direction (or the T-axis direction) and each connecting two outermost boundary lines of the coil electronic component 1000 opposing each other in the thickness direction (or the T-axis direction) that are shown in an optical microscope or scanning electron microscope (SEM) photograph of a cross-section taken in the length direction (or the L-axis direction) and the thickness direction (or the T-axis direction) at the center of the coil electronic component 1000 in the width direction (or the W-axis direction). Alternatively, the thickness of the coil electronic component 1000 may refer to the minimum value among lengths of a plurality of line segments parallel to the thickness direction (or the T-axis direction) and each connecting two outermost boundary lines of the coil electronic component 1000 opposing each other in the thickness direction (or the T-axis direction) that are shown in the above-mentioned photograph of the cross-section. Alternatively, the thickness of the coil electronic component 1000 may refer to an arithmetic average of lengths of at least two line segments among the plurality of line segments parallel to the thickness direction (or the T-axis direction) and each connecting two outermost boundary lines of the coil electronic component 1000 opposing each other in the thickness direction (or the T-axis direction) that are shown in the above-mentioned photograph of the cross-section.

A width of the coil electronic component 1000 may refer to the maximum value among lengths of a plurality of line segments parallel to the width direction (or the W-axis direction) and each connecting two outermost boundary lines of the coil electronic component 1000 opposing each other in the width direction (or the W-axis direction) that are shown in an optical microscope or scanning electron microscope (SEM) photograph of the cross-section taken in the length direction (or the L-axis direction) and the width direction (or the W-axis direction) at the center of the coil electronic component 1000 in the thickness direction (or the T-axis direction). Alternatively, the width of the coil electronic component 1000 may refer to the minimum value among lengths of a plurality of line segments parallel to the width direction (or the W-axis direction) and each connecting two outermost boundary lines of the coil electronic component 1000 opposing each other in the width direction (or the W-axis direction) that are shown in the above-mentioned photograph of the cross-section. Alternatively, the width of the coil electronic component 1000 may refer to an arithmetic average of lengths of at least two line segments among the plurality of line segments parallel to width direction (or the W-axis direction) and each connecting two outermost boundary lines of the coil electronic component 1000 opposing each other in the width direction (or the W-axis direction) that are shown in the above-mentioned photograph of the cross-section.

Meanwhile, each of the length, width and thickness of the coil electronic component 1000 may be measured using a micrometer measurement method. In the micrometer measurement method a zero point is set with a micrometer providing repeatability and reproducibility (Gage R&R), the coil electronic component 1000 according to this embodiment is inserted between tips of the micrometer, and a measurement lever of the micrometer is turned for the measurement. Meanwhile, when measuring the length of the coil electronic component 1000 by the micrometer measurement method, the length of the coil electronic component 1000 may mean a value measured once or an arithmetic average of values measured several times. This may be equally applied to measuring the width and the thickness of the coil electronic component 1000.

The body 100 constitutes an exterior of the coil electronic component 1000, and is a space where a magnetic path, which is a path through which the magnetic flux induced by the first coil 200 and the magnetic flux induced by the second coil 300 pass, is formed, when current is applied to the first coil 200 through the first external electrode 500 and the second external electrode 600, and current is applied to the second coil 300 through the third external electrode 700 and the fourth external electrode 800.

The body 100 surrounds and encapsulates the first coil 200 and the second coil 300, and includes a magnetic material. The body 100 may include magnetic particles and an insulating material in which the magnetic particles are dispersed.

The magnetic material may include a first metal magnetic powder, a second metal magnetic powder having a particle diameter larger than that of the first metal magnetic powder, and a third metal magnetic powder having a particle diameter larger than that of the second metal magnetic powder. An average particle diameter D₅₀ of the first metal magnetic powder may be 0.1 μm or more and 0.2 μm or less, an average particle diameter D₅₀ of the second metal magnetic powder may be 1 μm or more and 2 μm or less, and an average particle diameter D₅₀ of the third metal magnetic powder may be 25 μm or more and 30 μm or less.

The magnetic particles may be ferrite particles or metal magnetic particles exhibiting magnetic properties.

The ferrite particles may include, for example, at least one of a spinel type ferrite particle such as a Mg—Zn-based ferrite particle, a Mn—Zn-based ferrite particle, a Mn—Mg-based ferrite particle, a Cu—Zn-based ferrite particle, a Mg—Mn—Sr-based ferrite particle, and a Ni—Zn-based ferrite particle, a hexagonal ferrite such as a Ba—Zn-based ferrite particle, a Ba—Mg-based ferrite particle, a Ba—Ni-based ferrite particle, a Ba—Co-based ferrite particle, and a Ba—Ni—Co-based ferrite particle, a garnet type ferrite particle such as a Y-based ferrite particle, and a Li-based ferrite particle.

The metal magnetic particles may include two or more types of powders of different composition, and may include one or more selected from the group consisting of iron (Fe), silicon (Si), chromium (Cr), cobalt (Co), molybdenum (Mo), aluminum (AI), niobium (Nb), copper (Cu), and nickel (Ni). For example, the metal magnetic particles may include at least one of a pure iron, a Fe—Si-based alloy, a Fe—Si—Al-based alloy, a Fe—Ni-based alloy, a Fe—Ni—Mo-based alloy, a Fe—Ni—Mo—Cu-based alloy, a Fe—Co-based alloy, a Fe—Ni—Co-based alloy, a Fe—Cr-based alloy, a Fe—Cr—Si-based alloy, a Fe—Si—Cu—Nb-based alloy, a Fe—Ni—Cr-based alloy, and a Fe—Cr—Al-based alloy. Here, different compositions of metal magnetic particles may mean different contents.

The metal magnetic particle may be amorphous or crystalline. For example, the metal magnetic particle may be an Fe—Si—B—Cr-based amorphous alloy, but the present disclosure is not limited thereto. The metal magnetic particle may have an average particle diameter of about 0.1 μm to 30 μm, but is not limited thereto. In the present specification, the average particle diameter may refer to a particle size distribution expressed as D₉₀ or D₅₀. The particle size distribution is well known to those skilled in the art as an indicator that indicates what proportion of particles of what size (or particle diameter) are contained within a population of particles to be measured. D₅₀ (or a particle diameter corresponding to 50% of a cumulative volume of the particle size distribution) refers to an average particle diameter.

The metal magnetic particles may be two or more types of different metal magnetic particles. Here, that the types of the metal magnetic particles are different means that the metal magnetic particles are distinguished from each other in at least one of average particle diameter, composition, component ratio, crystallinity, and shape.

The insulating material may include epoxy, polyimide, liquid crystal polymer (LCP) or the like, alone or in combination, but is not limited thereto.

The method of forming the body 100 is not particularly limited. For example, the body 100 may be formed by placing sheets of a magnetic material on the upper and lower portions of the first coil 200 and the second coil 300, and then compressing and curing the sheets.

The first coil 200 and the second coil 300 may be disposed inside the body 100, exhibiting the characteristics of the coil electronic component. For example, when the coil electronic component 1000 according to the embodiment is utilized as a power inductor, when current is applied to the first coil 200 and the second coil 300, the coil electronic component may serve to stabilize the power source of an electronic device by storing energy in the form of a magnetic field and maintaining an output voltage.

The first coil 200 and the second coil 300 may be magnetically coupled to each other, thereby comprising a coupled inductor structure.

The first coil 200 and the second coil 300 may be in the shape of spirally wound metal (e.g., copper (Cu) or silver (Ag)) wire with a surface coated with an insulating material. That is, the first coil 200 and the second coil 300 may be wound coils. Each of the first coil 200 and the second coil 300 are not limited to a single wire, but may comprise a stranded wire or two or more wires.

The first coil 200 and the second coil 300 may be circular coils, but are not limited thereto. For example, the first coil 200 and the second coil 300 may be various known coils such as rectangular coils.

A cross-section of an individual wire of each of the first coil 200 and the second coil 300 may have various known shapes such as a rectangle, a circle, or an oval.

The first coil 200 and the second coil 300 may have a plurality of turns and may be edgewise coils.

For example, the first coil 200 may have an outermost turn coil C1 and an innermost turn coil C2 sequentially in a direction from the fifth surface S5 to the sixth surface S6 of the coil electronic component 1000. Meanwhile, although not shown in the drawings, at least one intermediate turn coil may be disposed between the outermost turn coil C1 and the innermost turn coil C2.

Similarly, the second coil 300 may have an outermost turn coil C1′ and an innermost turn coil C2′ sequentially in a direction from the sixth surface S6 to the fifth surface S5 of the coil electronic component 1000. Meanwhile, although not shown in the drawings, at least one intermediate turn coil may be disposed between the outermost turn coil C1′ and the innermost turn coil C2′.

An insulating film IF may be disposed along a surface of each of the plurality of turns of the first coil 200 and the second coil 300. The insulating film IF is for protecting and insulating the plurality of turns of the first coil 200 and the second coil 300, and may include a known insulating material such as parylene. The insulating material included in the insulating film IF is not particularly limited, and may be any insulating material. For example, the insulating film IF may be a polyurethane resin, a polyester resin, an epoxy resin, or a polyamideimide resin. The insulating film IF may be formed by a method such as vapor deposition, but is not limited thereto.

Meanwhile, the shapes of the first coil 200 and the second coil 300 are not limited to those described above and may have various known shapes. For example, the first coil 200 may have an outermost turn coil, one or more intermediate turn coils, and an innermost turn coil sequentially in an inward direction from the outer surface of the body 100. Similarly, the second coil 300 may have an outermost turn coil, one or more intermediate turn coils, and an innermost turn coil sequentially in an inward direction from the outer surface of the body 100.

The first coil 200 may include a winding portion 210 and lead-out portions 220.

The winding portion 210 may be a portion where the metal wire comprises at least one turn.

The lead-out portions 220 may extend from both ends of the winding portion 210, respectively, each of the lead-out portions 220 being exposed to the sixth surface S6 of the body 100. The lead-out portion 220 may include a first lead-out portion 223 and a second lead-out portion 225. The first lead-out portion 223 extends from one end of the winding portion 210 and is exposed from the sixth surface S6 of the body 100, and the second lead-out portion 225 extends from the other end of the winding portion 210 and is exposed from the sixth surface S6 of the body 100. The locations where the first lead-out portion 223 and the second lead-out portion 225 are exposed from the sixth surface S6 of the body 100 may be spaced apart from each other in the length direction (or the L-axis direction), but are not limited thereto.

The second coil 300 may include a winding portion 310 and a lead-out portions 320.

The winding portion 310 may be a portion where the metal wire comprises at least one turn.

The lead-out portions 320 may extend from both ends of the winding portion 310, respectively, each of the lead-out portions 320 being exposed from the sixth surface S6 of the body 100. The lead-out portions 320 may include a first lead-out portion 323 and a second lead-out portion 325. The first lead-out portion 323 extends from one end of the winding portion 310 and is exposed from the sixth surface S6 of the body 100, and the second lead-out portion 325 extends from the other end of the winding portion 310 and is exposed from the sixth surface S6 of the body 100. The locations where the first lead-out portion 323 and the second lead-out portion 325 are exposed from the sixth surface S6 of the body 100 may be spaced apart from each other in the length direction (or the L-axis direction), but are not limited thereto.

Although it has been described above that both the lead-out portions 220 of the first coil 200 and the lead-out portions 320 of the second coil 300 are exposed from the sixth surface S6 of the body 100, but the present embodiment is not limited thereto. For example, the lead-out portions 220 of the first coil 200 may be exposed from the third surface S3 of the body 100, and the lead-out portions 320 of the second coil 300 may be exposed from the fourth surface S4 of the body 100.

The first external electrode 500 and the second external electrode 600 are disposed outside the body 100, and electrically connected to the first coil 200. The first external electrode 500 is disposed on the sixth surface S6 of the body 100, and the first lead-out portion 223 of the first coil 200 is exposed from the sixth surface S6 of the body 100 and connected to the first external electrode 500.

The second external electrode 600 is disposed on the sixth surface S6 of the body 100, and the second lead-out portion 225 of the first coil 200 is exposed from the sixth surface S6 of the body 100 and connected to the second external electrode 600.

The first external electrode 500 may include an intermetallic compound 510, a conductive resin layer 520, and an electrode layer 530.

The intermetallic compound (IMC) 510 is disposed on both exposed ends of the first coil 200. That is, the intermetallic compound 510 is disposed on each of the exposed surface of the first lead-out portion 223 and the exposed surface of the second lead-out portion 225. The intermetallic compound 510 may be in the form of a plurality of islands, and may include silver (Ag)-tin (Sn). In addition, the plurality of islands may be layered.

The conductive resin layer 520 may be in contact with the exposed portion of the first lead-out portion 223 of the first coil 200 and the intermetallic compound 510. Meanwhile, the conductive resin layer 520 may cover a portion of the sixth surface S6 of the body 100.

The conductive resin layer 520 may include a base resin 521, a plurality of metal particles 523, and a conductive connection portion 525.

The conductive resin layer 520 may be formed in a process of applying a conductive paste, in which the base resin and the metal powder are dispersed, to the sixth surface S6 of the body 100, and then drying and curing the same. That is, the base resin of the conductive paste may become the base resin 521 of the conductive resin layer 520, and the metal powder of the conductive paste may become the conductive connection portion 525 of the conductive resin layer 520.

The conductive paste may include a first metal powder and a second metal powder.

A first metal included in the first metal powder may be a low melting point metal. That is, the first metal may be a metal with a melting point lower than the curing temperature of the base resin. The first metal may be, for example, tin (Sn) or an alloy comprising tin (Sn), such as a tin (Sn)-bismuth (Bi) alloy, a tin (Sn)-lead (Pb) alloy, a tin (Sn)-copper (Cu) alloy, a tin (Sn)-silver (Ag) alloy, and a tin (Sn)-silver (Ag)-copper (Cu) alloy.

A second metal included in the second metal powder may be a high melting point metal. That is, the second metal may be a metal with a melting point higher than the melting point of the first metal. The second metal may be, for example, copper (Cu), silver (Ag), etc.

In the drying and curing process described above, pressure and heat may cause particles of the first metal powder (hereinafter referred to as “first metal particles”) to melt and react with the particles of the second metal powder (hereinafter referred to as “second metal particles”) to form the conductive connection portion 525.

It is possible that some of the second metal particles in the conductive paste do not fully react with the first metal particles and remain. In this case, the remaining second metal particles may be present in the conductive resin layer, covered by the molten first metal particles. Meanwhile, all of the second metal particles in the conductive paste may react with the first metal particles. In this case, metal particles may not be present in the conductive resin layer. However, for ease of explanation, the present embodiment will be described below under the premise that the metal particles are present in the conductive resin layer.

The base resin 521 may include a thermosetting resin having electrical insulating properties. For example, the thermosetting resin may include an epoxy resin. However, the present embodiment is not limited thereto, and the thermosetting resin may be a bisphenol A resin, a glycol epoxy resin, a noblock epoxy resin, or a derivative thereof, which has a small molecular weight and is liquid at a room temperature.

The base resin 521 may bond the first lead-out portion 223 of the first coil 200 to the electrode layer 530.

The plurality of metal particles 523 may be disposed within the base resin 521. For example, the plurality of metal particles 523 may be dispersed in the base resin 521.

The metal particles 523 may include at least one of nickel (Ni), silver (Ag), copper (Cu) coated with silver, copper coated with tin (Sn), and copper.

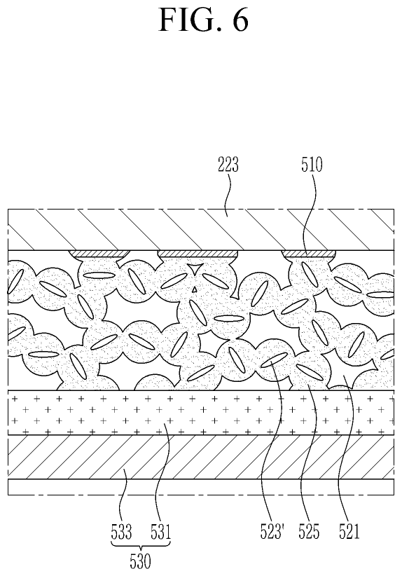

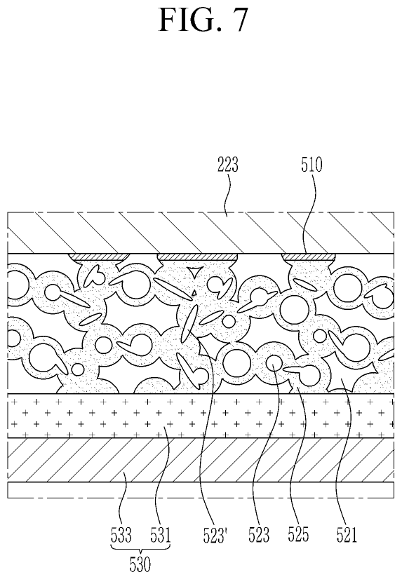

The metal particles 523 included in the conductive resin layer 520 are illustrated as spherical, but are not limited thereto, and may have other shapes. For example, flake-like metal particles 523′ may be dispersed within the conductive resin layer 520, as shown in FIG. 6. In another example, spherical metal particles 523 and the flake-like metal particle 523′ may be dispersed together in the conductive resin layer 520, as shown in FIG. 7.

The conductive connection portion 525 surrounds the plurality of metal particles 523, and is in contact with the intermetallic compound 510. The conductive connection portion 525 may surround the plurality of metal particles 523 and connect the metal particles 523 to each other, thereby minimizing stress within the body 100 and improving high temperature load characteristics and moisture load characteristics.

The conductive connection portion 525 may serve to lower the resistance of the conductive resin layer 520 by increasing the electrical conductivity of the conductive resin layer 520.

The electrode layer 530 is in contact with the conductive resin layer 520, and may be a plating layer. For example, the electrode layer 530 may have a structure in which a nickel (Ni) plating layer 531 and a tin (Sn) plating layer 533 are sequentially stacked. The nickel plating layer 531 is in contact with the conductive resin layer 520. That is, the nickel plating layer 531 is in contact with the base resin 521 and the conductive connection portion 525. The tin plating layer 533 may cover the nickel plating layer 531.

The intermetallic compound 510 may be disposed only at the interface of the conductive resin layer 520 and the exposed surface of the first lead-out portion 223, which is exposed from the sixth surface S6 of the body 100. That is, the intermetallic compound 510 may not be formed in the region of the sixth surface S6 of the body 100 where the first lead-out portion 223 is not exposed, and the conductive resin layer 520 may be disposed in that region to be in contact with the sixth surface S6 of the body 100.

The intermetallic compound 510 may be formed by the reaction of the metal component of the first lead-out portion 223 with the metal component of the low melting point metal particles included in the conductive paste described above. The low melting point metal particles contained in the conductive paste melt during curing of the conductive paste, and react with the metal component of the first lead-out portion 223 to form the intermetallic compound 510. As a result, the intermetallic compound 510 is only present at the interface of the conductive resin layer 520 and the exposed surface of the first lead-out portion 223, which is exposed from the sixth surface S6 of the body 100.

The intermetallic compound 510 may include the metal component of the low melting point metal particles and the metal component of the first lead-out portion 223. For example, the intermetallic compound 510 may comprise two or more alloys selected from tin (Sn), lead (Pb), indium (In), copper (Cu), silver (Ag), nickel (Ni), and bismuth (Bi). When the first lead-out portion 223 comprises copper (Cu), the intermetallic compound 510 may include a copper (Cu)-tin (Sn)-based alloy. Meanwhile, when it is said that the intermetallic compound 510 includes a copper (Cu)-tin (Sn)-based alloy may, it may mean that the alloy is an alloy comprising copper (Cu) and tin (Sn), or an alloy essentially comprising copper (Cu) and tin (Sn) and including other metallic or non-metallic elements.

Meanwhile, the intermetallic compound 510 may be confirmed by analyzing a boundary region between the first lead-out portion 223 and conductive resin layer 520 of the coil electronic component 1000 that is shown in an optical microscope or scanning electron microscope (SEM) photograph of a cross-section taken in the length direction (or the L-axis direction) and the thickness direction (or the T-axis direction) at the center of the coil electronic component 1000 in the width direction (or the W-axis direction). That is, in the above-described photograph of the cross-section photograph, the first lead-out portion 223, the intermetallic compound 510, and the conductive resin layer 520 may be distinguished from each other because they exhibit differences in contrast depending on the type of metal element, the content of a particular metal element, and whether or not a polymeric material is included. Therefore, the region that exists between the first lead-out portion 223 and the conductive resin layer 520 may be determined to be the intermetallic compound 510. Meanwhile, based on the contrast difference shown in the above-described photograph of the cross-section, the first lead-out portion 223 and the intermetallic compound 510, which do not include a polymeric material, and the conductive resin layer 520, which includes a polymeric material, may be distinguished from each other, and by performing energy dispersive spectroscopy (EDS) on the region not including a polymeric material (the first lead-out portion 223 and the intermetallic compound 510), the region having a content of at least 10 wt % of the metal component (e.g., tin (Sn)) of the above-mentioned low melting point metal particles may be determined as an intermetallic compound.

The second external electrode 600 has the same structure and composition as the first external electrode 500, with only its location being different from the first external electrode 500. Therefore, a redundant description of the structure and composition of the second external electrode 600 will be omitted.

The third external electrode 700 and the fourth external electrode 800 are disposed outside the body 100, and electrically connected to the second coil 300.

The third external electrode 700 is disposed on the sixth surface S6 of the body 100, and the first lead-out portion 323 of the second coil 300 is exposed from the sixth surface S6 of the body 100 and connected to the third external electrode 700.

The fourth external electrode 800 is disposed on the sixth surface S6 of the body 100, and the second lead-out portion 325 of the second coil 300 is exposed from the sixth surface S6 of the body 100 and connected to the fourth external electrode 800.

The third external electrode 700 and the fourth external electrode 800 have the same structure and composition as the first external electrode 500, with only their location being different from the first external electrode 500. Therefore, a redundant description of the structure and composition of the third external electrode 700 and the fourth external electrode 800 will be omitted.

Meanwhile, an insulating layer 900 may be disposed in a region other than the region where the first external electrode 500, the second external electrode 600, the third external electrode 700, and the fourth external electrode 800 are disposed on the body 100 of the coil electronic component 1000 according to the present embodiment. On the other hand, an insulating layer 900 may be present in regions between a portion where the first lead-out portion 223 of the first coil 200 is exposed, a portion where the second lead-out portion 225 of the first coil 200 is exposed, a portion where the first lead-out portion 323 of the second coil 300 is exposed, and a portion where the second lead-out portion 325 of the second coil 300 is exposed on the sixth surface S6 of the body 100. In this case, the first external electrode 500, the second external electrode 600, the third external electrode 700, and the fourth external electrode 800 may cover a portion of the insulating layer 900.

As described above, the insulating layer 900 may be disposed on at least portions of the first surface S1, second surface S2, third surface S3, fourth surface S4, fifth surface S5, and sixth surface S6 of the body 100 to prevent electrical short circuit between other electronic components and the external electrodes 500, 600, 700, and 800.

The insulating layer 900 may be utilized as a resist when forming the external electrodes 500, 600, 700, and 800 by electroplating, but the present disclosure is not limited thereto.

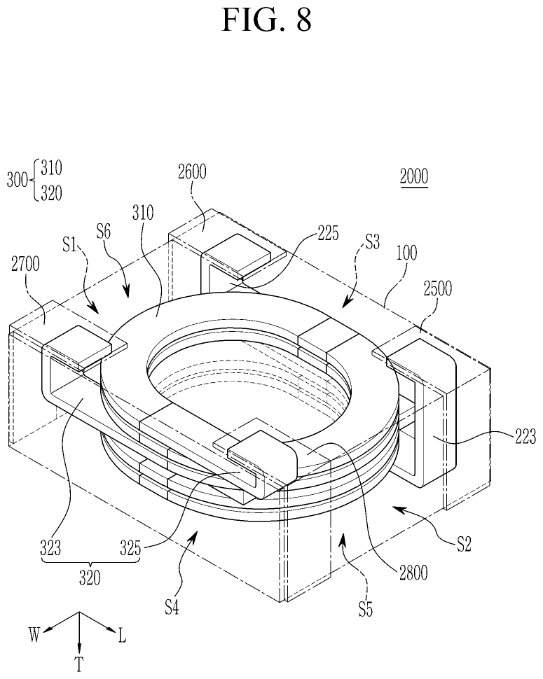

FIG. 8 is a perspective view schematically illustrating a coil electronic component according to another embodiment.

Referring to FIG. 8, a first external electrode 2500 of a coil electronic component 2000 according to another embodiment may be connected to the first lead-out portion 223 of the first coil 200 on the sixth surface S6 of the body 100, and may extend onto the second surface S2 of the body 100. In addition, a second external electrode 2600 may be connected to the second lead-out portion 225 of the first coil 200 on the sixth surface S6 of the body 100, and may extend onto the first surface S1 of the body 100.

A third external electrode 2700 may be connected to the first lead-out portion 323 of the second coil 300 on the sixth surface S6 of the body 100, and may extend onto the first surface S1 of the body 100. In addition, a fourth external electrode 2800 may be connected to the second lead-out portion 325 of the second coil 300 on the sixth surface S6 of the body 100, and may extend onto the second surface S2 of the body 100.

Except for the above, the remaining components are the same as those of the coil electronic component shown in FIG. 1, so a redundant description thereof will be omitted.

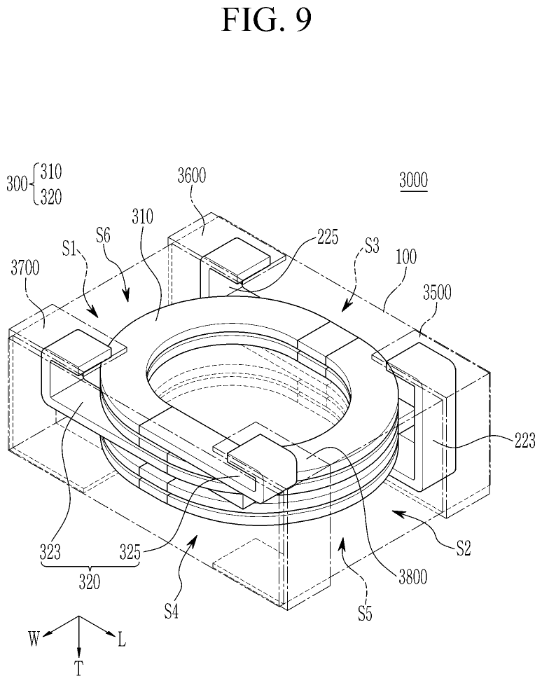

FIG. 9 is a perspective view schematically illustrating a coil electronic component according to still another embodiment.

Referring to FIG. 9, a first external electrode 3500 of a coil electronic component 3000 according to still another embodiment may be connected to the first lead-out portion 223 of the first coil 200 on the sixth surface S6 of the body 100, and may extend onto the second surface S2 and the fifth surface S5 of the body 100. In addition, a second external electrode 3600 may be connected to the second lead-out portion 225 of the first coil 200 on the sixth surface S6 of the body 100, and may extend onto the first surface S1 and the fifth surface S5 of the body 100.

A third external electrode 3700 may be connected to the first lead-out portion 323 of the second coil 300 on the sixth surface S6 of the body 100, and may extend onto the first surface S1 and fifth surface S5 of the body 100. In addition, a fourth external electrode 3800 may be connected to the second lead-out portion 325 of the second coil 300 on the sixth surface S6 of the body 100, and may extend onto the second surface S2 and fifth surface S5 of the body 100.

Except for the above, the remaining components are the same as those of the coil electronic component shown in FIG. 1, so a redundant description thereof will be omitted.

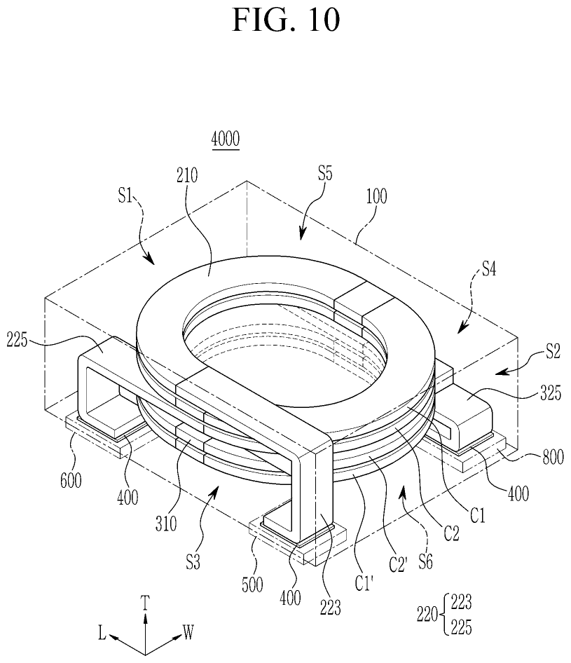

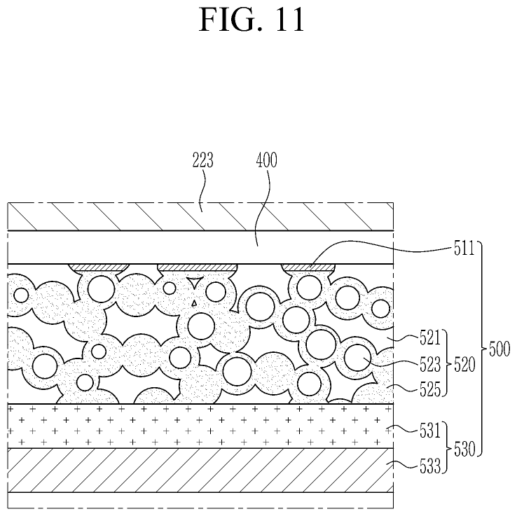

FIG. 10 is a perspective view schematically illustrating a coil electronic component according to yet another embodiment; and FIG. 11 is a partially enlarged cross-sectional view schematically illustrating the coil lead-out portion and the external electrode of the coil electronic component of FIG. 10.

Referring to FIGS. 10 and 11, a coil electronic component 4000 may include a body 100, a first coil 200, a second coil 300, a metal layer 400, a first external electrode 500, a second external electrode 600, a third external electrode 700, and a fourth external electrode 800.

The metal layer 400 may be disposed on both exposed ends of the first coil 200. That is, the metal layer 400 may be disposed on each of the exposed surface of the first lead-out portion 223 and the exposed surface of the second lead-out portion 225. The metal layer 400 may include, for example, copper (Cu) and may be a plating layer.

The metal layer 400 is in contact with the exposed portion of the first lead-out portion 223 and may cover a portion of the sixth surface S6 of the body 100. That is, an area of the metal layer 400 may be larger than an area of the exposed surface of the first lead-out portion 223, and the metal layer 400 may cover the exposed surface of the first lead-out portion 223. When the first lead-out portion 223 of the first coil 200 and the metal layer 400 are made of the same material (e.g., copper (Cu)), the metal layer 400 may have the effect of expanding the first lead-out portion 223. If it is structurally difficult to increase the area of the first lead-out portion 223 of the first coil 200, the metal layer 400 may be formed to cover the exposed surface of the first lead-out portion 223, and then the first external electrode 500 may be connected to the metal layer 400. Accordingly, the first lead-out portion 223 and the first external electrode 500 may be strongly coupled. The above description may be equally applied to the second lead-out portion 225, so a redundant description thereof will be omitted.

The first external electrode 500 may include an intermetallic compound 511, a conductive resin layer 520, and an electrode layer 530.

The intermetallic compound 511 is disposed on the metal layer 400. The intermetallic compound 511 may be in the form of a plurality of islands, and may include silver (Ag)-tin (Sn). In addition, the plurality of islands may be layered.

The conductive resin layer 520 may be in contact with the metal layer 400 and the intermetallic compound 511. Meanwhile, the conductive resin layer 520 may cover a portion of the sixth surface S6 of the body 100.

The conductive resin layer 520 may include a base resin 521, a plurality of metal particles 523, and a conductive connection portion 525.

The base resin 521 may bond the metal layer 400 and the electrode layer 530.

The plurality of metal particles 523 may be disposed within the base resin 521. For example, the plurality of metal particles 523 may be dispersed in the base resin 521.

The conductive connection portion 525 surrounds the plurality of metal particles 523, and may be in contact with the intermetallic compound 511.

The electrode layer 530 is in contact with the conductive resin layer 520, and may be a plating layer.

The intermetallic compound 511 may be disposed only at the interface of the metal layer 400 and the conductive resin layer 520. That is, the intermetallic compound 510 may not be formed in the region of the sixth surface S6 of the body 100 where the metal layer 400 is not disposed, and the conductive resin layer 520 may be disposed in that region to be in contact with the sixth side S6 of the body 100.

The intermetallic compound 511 may be formed by the reaction of the metal component of the metal layer 400 with the metal component of the low melting point metal particles included in the conductive paste described above. The low melting point metal particles contained in the conductive paste melt during curing of the conductive paste, and react with the metal component of the metal layer 400 to form the intermetallic compound 511. As a result, the intermetallic compound 511 is only present at the interface of the metal layer 400 and the conductive resin layer 520.

The intermetallic compound 511 may include the metal component of the low melting point metal particles and the metal component of the metal layer 400. For example, the intermetallic compound 511 may comprise two or more alloys selected from tin (Sn), lead (Pb), indium (In), copper (Cu), silver (Ag), nickel (Ni), and bismuth (Bi). When the metal layer 400 comprises copper (Cu), the intermetallic compound 511 may include a copper (Cu)-tin (Sn)-based alloy. Meanwhile, when it is said that the intermetallic compound 511 includes a copper (Cu)-tin (Sn)-based alloy, it may mean that the alloy is an alloy comprising copper (Cu) and tin (Sn), or an alloy essentially comprising copper (Cu) and tin (Sn) and including other metallic or non-metallic elements.

Meanwhile, the intermetallic compound 511 may be confirmed by analyzing a boundary region between the metal layer 400 and conductive resin layer 520 of the coil electronic component 1000 that is shown in an optical microscope or scanning electron microscope (SEM) photograph of a cross-section taken in the length direction (or the L-axis direction) and the thickness direction (or the T-axis direction) at the center of the coil electronic component 1000 in the width direction (or the W-axis direction). That is, in the above-described photograph of the cross-section, the metal layer 400, the intermetallic compound 511, and the conductive resin layer 520 may be distinguished from each other because they exhibit differences in contrast depending on the type of metal element, the content of a particular metal element, and whether or not a polymeric material is included. Therefore, the region that exists between the metal layer 400 and the conductive resin layer 520 may be determined to be the intermetallic compound 511. Meanwhile, based on the contrast difference shown in the above-described photograph of the cross-section, the metal layer 400 and the intermetallic compound 511, which do not include a polymeric material, and the conductive resin layer 520, which includes a polymeric material, may be distinguished from each other, and by performing energy dispersive spectroscopy (EDS) on the region not including a polymeric material (the metal layer 400 and the intermetallic compound 511), the region having a content of at least 10 wt % of the metal component (e.g., tin (Sn)) of the above-mentioned low melting point metal particles may be determined as an intermetallic compound.

The second external electrode 600 has the same structure and composition as the first external electrode 500, with only its location being different from the first external electrode 500. Therefore, a redundant description of the structure and composition of the second electrode 600 will be omitted.

The third external electrode 700 and the fourth external electrode 800 are disposed outside the body 100, and electrically connected to the second coil 300.

The third external electrode 700 is disposed on the sixth surface S6 of the body 100, and the first lead-out portion 323 of the second coil 300 is exposed from the sixth surface S6 of the body 100 and connected to the third external electrode 700.

The fourth external electrode 800 is disposed on the sixth surface S6 of the body 100, and the second lead-out portion 325 of the second coil 300 is exposed from the sixth surface S6 of the body 100 and connected to the fourth external electrode 800.

The third external electrode 700 and the fourth external electrode 800 have the same structure and composition as the first external electrode 500, with only their location being different from the first external electrode 500. Therefore, a redundant description of the structure and composition of the third external electrode 700 and those of the fourth external electrode 800 will be omitted.

Except for the above, the remaining components are the same as those of the coil electronic component shown in FIG. 1, so a description thereof will be omitted.

Although the embodiments of the present disclosure have been described, it is to be understood that the present disclosure is not limited to the disclosed embodiments. Various modifications may be made within the scopes of the claims, the description of the present disclosure and the accompanying drawings, which also fall within the scope of the present disclosure.

What is claimed is:

1. A coil electronic component comprising:
a body surrounding a first coil with both ends exposed to the outside of the body and a second coil with both ends exposed to the outside of the body, and including a magnetic material; and
external electrodes connected to the first coil and the second coil,
wherein one of the external electrodes includes an intermetallic compound disposed on the exposed ends of the first coil and the second coil, respectively.

2. The component of claim 1, wherein
the one of the external electrodes further includes:
a conductive resin layer in contact with the intermetallic compound, and
an electrode layer connected to the conductive resin layer.

3. The component of claim 2, wherein
the conductive resin layer includes:
a base resin,
a plurality of metal particles disposed within the base resin, and
a conductive connection portion surrounding the plurality of metal particles and being in contact with the intermetallic compound.

4. The component of claim 3, wherein
the electrode layer is disposed on the conductive resin layer and is in contact with the conductive connection portion.

5. The component of claim 3, wherein
the plurality of metal particles has one of a spherical shape, a flake shape, and a mixture of spherical and flake shapes.

6. The component of claim 1, wherein
the intermetallic compound is in a form of a plurality of islands.

7. The component of claim 1, wherein
the intermetallic compound includes silver (Ag)-tin (Sn).

8. The component of claim 1, wherein
the first coil includes at least one turn of a first conductive wire, and
the second coil includes at least one turn of a second conductive wire.

9. The component of claim 1, wherein
the first coil includes a first lead-out portion and a second lead-out portion that are exposed to the outside of the body, and
the second coil includes a third lead-out portion and a fourth lead-out portion that are exposed to the outside of the body.

10. The component of claim 9, wherein
the intermetallic compound is disposed on exposed surfaces of the first lead-out portion, the second lead-out portion, the third lead-out portion, and the fourth lead-out portion, and
the external electrodes include:
a first external electrode connected to the first lead-out portion,
a second external electrode connected to the second lead-out portion,
a third external electrode connected to the third lead-out portion, and
a fourth external electrode connected to the fourth lead-out portion.

11. A coil electronic component comprising:
a body surrounding a first coil with both ends exposed to the outside of the body and a second coil with both ends exposed to the outside of the body, and including a magnetic material;
a metal layer disposed outside the body and being in contact with the exposed ends of the first coil and the second coil, respectively; and
external electrodes connected to the metal layer,
wherein one of the external electrodes includes an intermetallic compound disposed on the metal layer.

12. The component of claim 11, wherein
the metal layer includes copper (Cu).

13. The component of claim 11, wherein
the one of the external electrodes further includes:
a conductive resin layer in contact with the intermetallic compound, and
an electrode layer connected to the conductive resin layer.

14. The component of claim 13, wherein
the conductive resin layer includes:
a base resin,
a plurality of metal particles disposed within the base resin, and
a conductive connection portion surrounding the plurality of metal particles and being in contact with the intermetallic compound.

15. The component of claim 14, wherein
the electrode layer is disposed on the conductive resin layer and is in contact with the conductive connection portion.

16. The component of claim 11, wherein
the intermetallic compound includes silver (Ag)-tin (Sn).

17. The component of claim 11, wherein
the first coil includes a first lead-out portion and a second lead-out portion that are exposed the outside of the body, and
the second coil includes a third lead-out portion and a fourth lead-out portion that are exposed the outside of the body.

18. The component of claim 17, wherein
the intermetallic compound is disposed on exposed surfaces of the first lead-out portion, the second lead-out portion, the third lead-out portion, and the fourth lead-out portion, and
the external electrodes include:
a first external electrode connected to the first lead-out portion,
a second external electrode connected to the second lead-out portion,
a third external electrode connected to the third lead-out portion, and
a fourth external electrode connected to the fourth lead-out portion.

19. A coil electronic component comprising:
a body including a magnetic material;
a first coil disposed in the body and including first and second lead-out portions extending to one surface of the body;
a second coil stacked on or below the first coil inside the body, and including third and fourth lead-out portions extending to the one surface of the body;
first to fourth external electrodes disposed on the one surface of the body to respectively connect to the first to fourth lead-out portions;
a metal layer disposed between a respective one of the first to fourth external electrodes and a respective one of the first to fourth lead-out portions,
wherein the metal layer has an area greater than an area of the respective one of the first to fourth lead-out portions exposed from the one surface of the body.

20. The component of claim 19, wherein
the respective one of the first to fourth external electrodes includes:
an intermetallic compound disposed on the metal layer,
a conductive resin layer in contact with the intermetallic compound, and
an electrode layer connected to the conductive resin layer.
